(19) United States
(12) Patent Application Publication
(10) Pub. No.: US 2018/0321142 A1
(43) Pub. Date: Nov. 8, 2018

(54) ROAD SURFACE DETECTION SYSTEM

(71) Applicant: MAGNA ELECTRONICS INC., Auburn Hills, MI (US)

(72) Inventor: Heinz B. Seifert, Ortonville, MI (US)

(21) Appl. No.: 15/968,811

(22) Filed: May 2, 2018

Related U.S. Application Data
(60) Provisional application No. 62/501,987, filed on May 5, 2017.

(51) Int. Cl. G01N 21/3554

(52) U.S. Cl. CPC G01N 21/3554; G05D 1/0231

(57) ABSTRACT

A road surface detection system for a vehicle includes an optical emitter disposed at the vehicle and configured to emit a beam of light downward and forward of the vehicle. A receiver is disposed at the vehicle so as to receive light emitted by the optical emitter that is scattered or reflected from the road surface. The receiver includes a prism and an imager, and the prism refracts the light so that the imager captures received light that is refracted by the prism. A control includes a processor operable to process image data captured by the imager. The control, responsive to processing of image data captured by the imager, determines spectral characteristics of materials present on the road surface. The control may determine the type of material present on the road surface by determining the parts of the spectrum absorbed by the material.

### CROSS REFERENCE TO RELATED APPLICATION

The present application is related to U.S. provisional application Ser. No. 62/501,987, filed May 5, 2017, which is hereby incorporated herein by reference in its entirety.

### FIELD OF THE INVENTION

The present invention relates generally to a vehicle sensing system for a vehicle and, more particularly, to a vehicle sensing system that utilizes one or more cameras at a vehicle.

### BACKGROUND OF THE INVENTION

Motor vehicles may encounter substances on the road that reduce the road surface friction coefficient (e.g. oil spills or sand or gravel). When the vehicle travels on these coated surfaces the vehicle may get out of control when attempting to navigate a curve or when deceleration or accelerating. This is especially important for autonomous vehicles that cannot rely on a human driver to detect these hazards; these vehicles need to detect the hazards in time and then react proactively by, for example, avoiding the hazard or deceleration or by adapting other maneuvers. The system must detect changes very quickly (multiple scans per second) to accommodate fast moving vehicles. The system should have no moving parts to survive for at least ten years in a motor vehicle. Examples of known systems are described in U.S. Pat. No. 9,304,081 and U.S. Pat. No. 9,297,755.

### SUMMARY OF THE INVENTION

The present invention provides a road detection system that utilizes reflectance spectroscopy to determine the road surface composition in front of a moving vehicle to detect substances like water, ice, oil, snow, dirt or sand that reduce the road surface friction and present a hazard. The road surface detection system includes a broad band optical emitter disposed at the vehicle and configured to emit a beam of light downward and forward of the vehicle, and a receiver disposed at the vehicle so as to receive light emitted by the broad band optical emitter that is scattered or reflected from the road surface. The receiver includes a prism and an imager, and the prism refracts the light so that the imager captures image data representative of received light that is refracted by the prism. A control includes a processor operable to process image data captured by the imager. The control, responsive to processing of image data captured by the imager, determines a pattern of spectral absorption for materials present on the road surface. The control may determine the type of material present on the road surface by determining the parts of the spectrum absorbed by the material.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle with a road detection system in accordance with the present invention;

FIG. 2 is a diagram showing receiver light refraction and detection;

FIG. 3 is a diagram of a rotating prism and beam splitter suitable for use in the system of the present invention;

FIG. 4 is an example absorption spectrum;

FIG. 5 is a reference spectrum; and

FIG. 6 is a spectrum with additional absorption lines.

### DESCRIPTION OF THE PREFERRED EMBODIMENTS

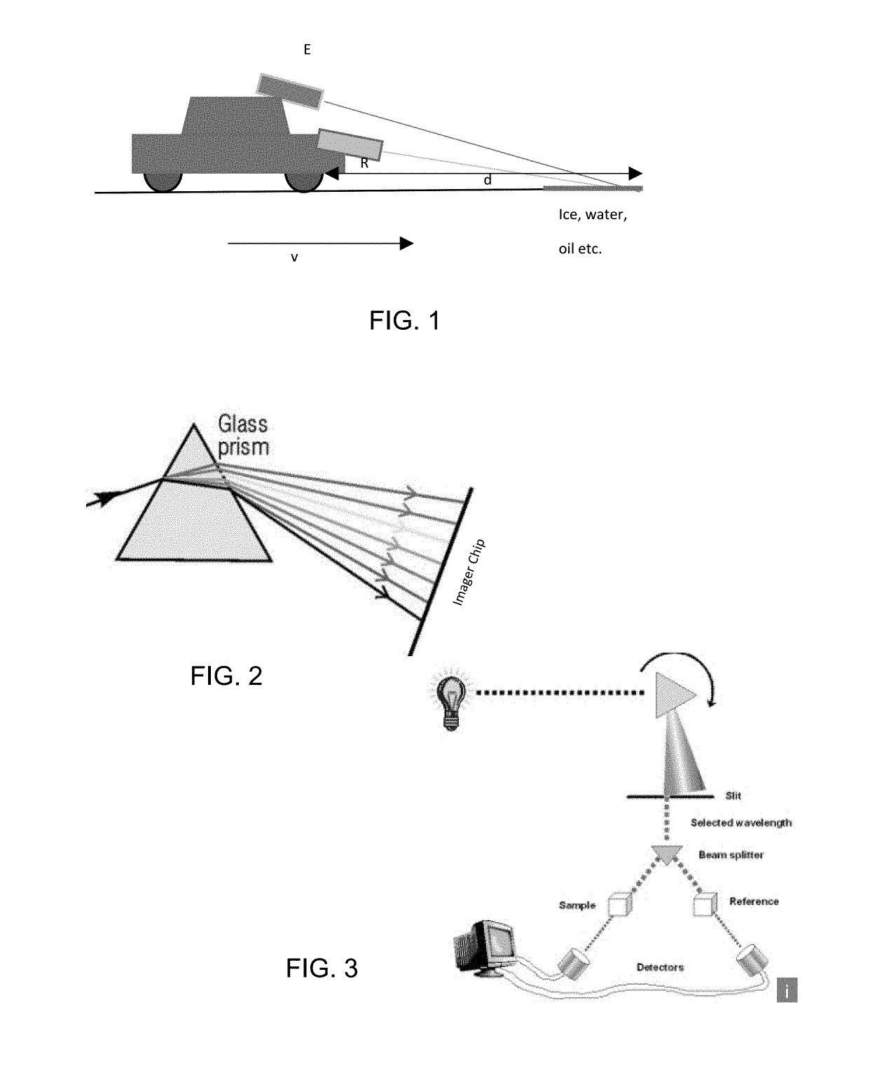

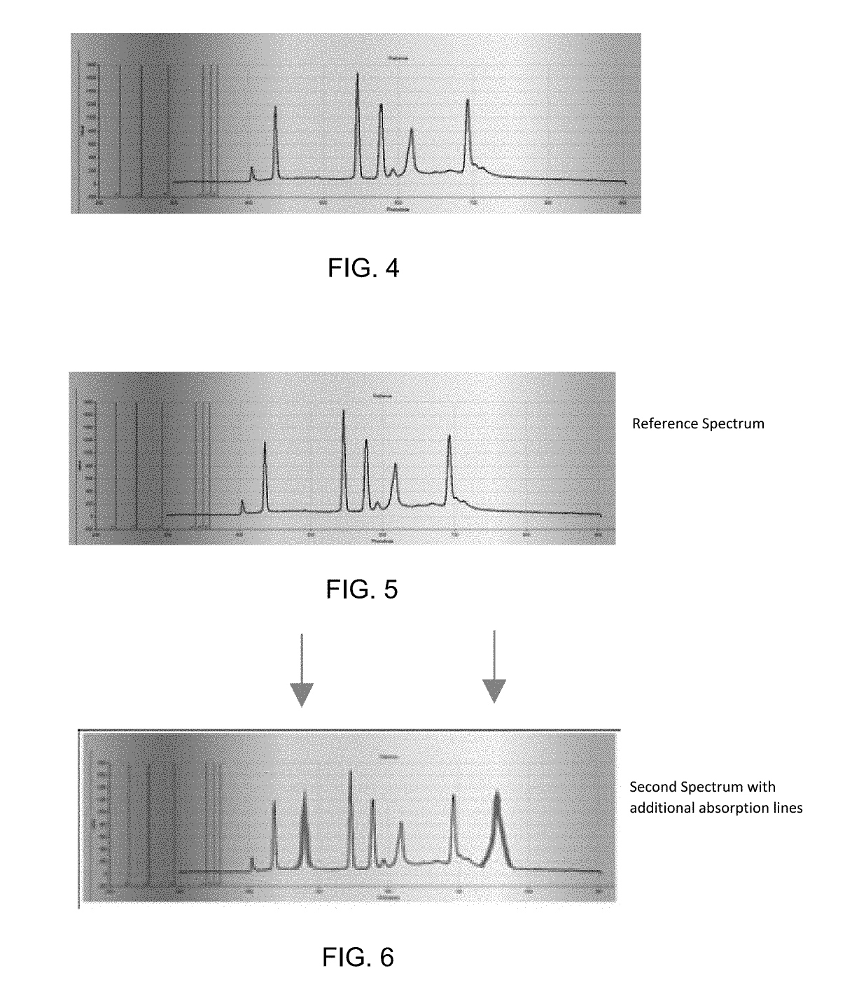

Referring now to the drawings and the illustrative embodiments depicted therein, a road surface detector of a vehicle includes a broad band optical emitter E and a receiver R (FIG. 1). The broad band optical emitter E emits a beam of light that hits the road surface. A part of the light is scattered or reflected from the road surface and is received by the receiver R.

In the receiver R, a prism (see FIG. 2) refracts the light and the imager chip captures the intensity of the spectrum. The system may scan a wide spectrum using a rotating prism and a slit (such as shown in FIG. 3). Different materials present on the road surface absorb parts of the spectrum and generate an absorption ‘fingerprint’ of the material present on the road surface.

A machine learning algorithm (deep neural network) is utilized to analyze the recorded spectra to determine the presence of one or multiple substance quickly and securely.

The receiver R then compares the spectrum received against prerecorded spectra of water, ice, oil, snow, dirt, sand granules and other substances that were recorded previously and need to be detected. An array of receivers may be provided that scan multiple areas of the road surface at once.

The receiver R then transmits a signal indicative of detection of the presence of oil, sand, ice or water on the road at the known distance d and allows the vehicle to react to the potential hazard.

The above description simplifies the idea to illustrate the concept. The real system will take the following into account:
The uncoated road surface varies greatly while the vehicle is traveling on the road. The surface albedo depends on the material (asphalt, concrete, dirt) and the age of the road (new asphalt roads have a low albedo, new concrete roads have a high albedo).
Material roughness (fine granules scatter light differently than large granules)

The system will constantly calibrate itself by determining the change of the recorded spectra compared to the next recorded spectrum. The system will take a snapshot of one spectrum and store it as the reference spectrum. The next recorded spectrum will be compared to the first spectrum and the system will analyze the changes between the two spectra. Any change of the two spectra will indicate the presence of additional substances on the road surface.

### Machine Learning Algorithm

The system will use a deep neural network (DNN) classifier to filter trained spectra from the road spectrum. The classifier will be trained with a sufficient set of spectrums for all the substances of interest (e.g., water, ice, oil, engine coolant, etc.). The classifier will be able to recognize the influence of the absorption lines caused by the substances of interest on the road spectrum and then flag the presence of the substance.

The machine learning algorithm will also be able to detect the influence of substances like fine sand on the road surface. Since these conglomerates of substances will impact the whole spectrum (due to scattering and absorption) depending on the grain size of the material the classifier will analyze the whole intensity distribution across all wavelengths to detect the presence of fine grain material.

Reflectance spectroscopy is the study of light as a function of wavelength that has been reflected or scattered from a solid, liquid, or gas. As photons enter a mineral, some are reflected from grain surfaces, some pass through the grain, and some are absorbed. Those photons that are reflected from grain surfaces or refracted through a particle are said to be scattered. Scattered photons may encounter another grain or be scattered away from the surface so they may be detected and measured.

All materials have a complex index of refraction (equation 4): m=n−jK;

where m is the complex index of refraction n is the real part of the index j=(−1)1/2 K is the imaginary part of the index of refraction, sometimes called extinction coefficient (see http://www.and/or.com/leaming-academy/absorption-transmission-reflection-spectroscopy-an-introduction-to-absorption-transmission-reflection-spectroscopy, which is hereby incorporated herein by reference in its entirety.

When photons enter an absorbing medium, they are absorbed according to the Beer-Lambert Law. The absorption coefficient is related to the complex index of refraction by the following equation: ε=4K/λ. The reflection of light, R, normally incident onto a plane surface is described by the Fresnel equation: R=[(n−1)²+K²]/[(n+1)²+K²]

At angles other than normal, the reflectance is a complex trigonometric function involving the polarization direction of the incident beam.

Scattering can also be thought of as scrambling information. The information is made more complex, and because scattering is a non-linear process, recovery of quantitative information is difficult. In transmission, light passes through a slab of material. There is little or no scattering (none in the ideal case; but there are always internal reflections from the surfaces of the medium). In reflectance, however, the optical path of photons is a random walk. At each grain the photons encounter, a certain percentage are absorbed. If the grain is bright, like a quartz grain at visible wavelengths, most photons are scattered and the random walk process can go on for hundreds of encounters. If the grains are dark, the majority of photons will be absorbed at each encounter and essentially all photons will be absorbed in only a few encounters. This process also enhances weak features not normally seen in transmittance, further increasing reflectance spectroscopy as a diagnostic tool. In a mixture of light and dark grains (e.g., quartz and magnetite) the photons have such a high probability of encountering a dark grain that a few percent of dark grains can drastically reduce the reflectance, much more than their weight fraction. A general rule with mixtures is that at any given wavelength, the darker component will tend to dominate the reflectance. The amount of light scattered and absorbed by a grain is dependent on grain size. A larger grain has a larger internal path where photons may be absorbed according to Beers Law. It is the reflection from the surfaces and internal imperfections that influence the scattering. In a smaller grain there are proportionally more surface reflections compared to internal photon path length, or in other words, the surface-to-volume ratio is a function of grain size. Absorptions in a spectrum have two components: continuum and individual features. The continuum is the “background absorption” onto which other absorption features are superimposed. It may be due to the wing of a larger absorption feature.

The present invention thus uses an optical beam emitter and a receiver with a prism to determine the pattern of spectral absorption for materials present on the road and to recognize the material or type of material based on the determined pattern. The system uses a wide spectrum of light to identify substances such as oil, gravel, etc. using reflective absorption spectroscopy. The system defines at least one wave length that does not get absorbed by any of the target substances to provide a reference (or develop another method to get the reference signal), such as shown in FIG. 5. The system scans an area quickly enough and is able to resolve a relatively small area (such as around one square meter or thereabouts) patch while the vehicle is traveling at 130 km/h.

The camera or imager or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A road surface detection system for a vehicle, said road surface detection system comprising:
an optical emitter disposed at a vehicle and configured to emit a beam of light downward and forward of the vehicle;
a receiver disposed at the vehicle so as to receive light emitted by said optical emitter that is scattered or reflected from the road surface;
wherein said receiver comprises a prism and an imager, and wherein said prism refracts the received light so that the imager captures image data representative of received light that is emitted by said optical emitter and scattered or reflected from the road surface and refracted by said prism;
a control comprising a processor operable to process image data captured by said imager; and
wherein said control, responsive to processing by said processor of image data captured by said imager that is representative of received light that is emitted by said optical emitter and scattered or reflected from the road surface and refracted by said prism, determines a spectral characteristic for materials present at the road surface.

2. The road surface detection system of claim 1, wherein the determined spectral characteristic for materials present at the road surface comprises a pattern of spectral absorption for materials present at the road surface.

3. The road surface detection system of claim 1, wherein said control determines the type of material present at the road surface by determining the spectral characteristic.

4. The road surface detection system of claim 3, wherein said control determines the type of material present at the road surface by determining parts of the electromagnetic spectrum that are absorbed by the material present at the road surface.

5. The road surface detection system of claim 3, wherein determination of the types of materials present at the road surface comprises said control comparing determined patterns of spectral characteristics against predetermined spectral characteristics for water, ice, oil, snow, dirt and sand granules.

6. The road surface detection system of claim 3, wherein said control, responsive to determination of the type of material present at the road surface, communicates a signal indicative of the determined type of material present at the road surface.

7. The road surface detection system of claim 6, wherein said control communicates the signal to an autonomous control system that is driving the vehicle.

8. The road surface detection system of claim 6, wherein said control communicates the signal to alert a driver of the vehicle of the determined type of material present at the road surface.

9. The road surface detection system of claim 1, wherein said processor comprises a machine learning algorithm that analyzes the determined spectral characteristics to determine the presence of one or multiple materials present at the road surface.

10. The road surface detection system of claim 1, wherein said optical emitter comprises a broad band optical emitter.

11. The road surface detection system of claim 1, wherein said control comprises a deep neural network classifier to filter predetermined spectral characteristics from the determined spectral characteristics.

12. The road surface detection system of claim 11, wherein said deep neural network classifier is operable to recognize influence of granular materials present at the road surface.

13. The road surface detection system of claim 12, wherein said classifier analyzes an intensity distribution across all wavelengths emitted to detect the presence of fine grain material present at the road surface.

14. A road surface detection system for a vehicle, said road surface detection system comprising:
an optical emitter disposed at a vehicle and configured to emit a beam of light downward and forward of the vehicle;
a receiver disposed at the vehicle so as to receive light emitted by said optical emitter that is scattered or reflected from the road surface;
wherein said receiver comprises a prism and an imager, and wherein said prism refracts the received light so that the imager captures image data representative of received light that is emitted by said optical emitter and scattered or reflected from the road surface and refracted by said prism;
a control comprising a processor operable to process image data captured by said imager;
wherein said control, responsive to processing by said processor of image data captured by said imager that is representative of received light that is emitted by said optical emitter and scattered or reflected from the road surface and refracted by said prism, determines a pattern of spectral absorption for materials present at the road surface;
wherein said control determines the type of material present at the road surface by determining the pattern of spectral absorption; and
wherein said control, responsive to determination of the type of material present at the road surface, communicates a signal indicative of the determined type of material present at the road surface.

15. The road surface detection system of claim 14, wherein said control determines the type of material present at the road surface by determining parts of the electromagnetic spectrum that are absorbed by the material present at the road surface.

16. The road surface detection system of claim 14, wherein said control communicates the signal to an autonomous control system that is driving the vehicle.

17. The road surface detection system of claim 14, wherein said control communicates the signal to alert a driver of the vehicle of the determined type of material present at the road surface.

18. A road surface detection system for a vehicle, said road surface detection system comprising:
an optical emitter disposed at a vehicle and configured to emit a beam of light downward and forward of the vehicle;
a receiver disposed at the vehicle so as to receive light emitted by said optical emitter that is scattered or reflected from the road surface;
wherein said receiver comprises a prism and an imager, and wherein said prism refracts the received light so that the imager captures image data representative of received light that is emitted by said optical emitter and scattered or reflected from the road surface and refracted by said prism;
a control comprising a processor operable to process image data captured by said imager;
wherein said control, responsive to processing by said processor of image data captured by said imager that is representative of received light that is emitted by said optical emitter and scattered or reflected from the road surface and refracted by said prism, determines a spectral characteristic for materials present at the road surface;
wherein said control determines the type of material present at the road surface by determining the spectral characteristic;
wherein determination of the types of materials present at the road surface comprises said control comparing determined patterns of spectral characteristics against predetermined spectral characteristics for water, ice, oil, snow, dirt and sand;
wherein said control, responsive to determination of the type of material present at the road surface, communicates a signal indicative of the determined type of material present at the road surface; and
wherein said control communicates the signal to one of (i) an autonomous control system that is driving the vehicle and (ii) alert a driver of the vehicle of the determined type of material present at the road surface.

19. The road surface detection system of claim 18, wherein said control communicates the signal to an autonomous control system that is driving the vehicle.

20. The road surface detection system of claim 18, wherein said control communicates the signal to alert a driver of the vehicle of the determined type of material present at the road surface.
